(19) United States
(12) Patent Application Publication
(10) Pub. No.: US 2010/0211809 A1
(43) Pub. Date: Aug. 19, 2010

(54) ELECTRONIC CIRCUIT, PRINTING APPARATUS AND ELECTRONIC APPARATUS

(75) Inventor: Masayoshi Shimada, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/704,475

(22) Filed: Feb. 11, 2010

(30) Foreign Application Priority Data
Feb. 13, 2009 (JP) 2009-031340

(51) Int. Cl. G06F 1/32; G06F 12/02; G06F 12/08

(52) U.S. Cl. 713/323; 711/104; 711/102; 711/118; 711/E12.008; 711/E12.017

(57) ABSTRACT

Disclosed is an electronic circuit including at least one circuit group that performs a predetermined process based on information stored in a register. Power supply lines are separately provided to a register, which stores data necessary for returning from a power saving state, and a circuit section other than the register, and power is supplied only to the register in the power saving state.

### BACKGROUND

1. Technical Field

The present invention relates to an electronic circuit, a printing apparatus and an electronic apparatus, and more particularly to an electronic circuit including at least one circuit group that performs a predetermined process based on information stored in a register, a printing apparatus and an electronic apparatus which include the electronic circuit.

2. Related Art

Demands for an electronic apparatus to improve power savings have been increasing every year from an ecological point of view. However, in general, power supply to an integrated circuit is frequently stopped in a power saving mode. For this reason, information, which is stored in a cache of an operation circuit of a CPU or the like of the integrated circuit, and setting values, which are stored in registers of each module of the integrated circuit, may be lost. Thus, time is required for returning from the power saving mode.

In order to cope with the problem, research has been conducted to maintain the setting values stored in the cache of the CPU and the registers of each module. For example, according to JP-A-2004-112718, during an operation in a normal mode before entering the power saving mode, after an operating system and basic application programs stored in advance in a ROM are entirely or partially copied into an external RAM for which a power source is not turned off, codes and data are read out from the external RAM and are executed in a returning process from the power saving mode.

Further, for example, according to JP-A-2003-122461, after a semiconductor integrated circuit is divided into an internal logic block and an input/output pad cell block, the state of a D flip flop of the internal logic block is always linked to a RS latch of the input/output pad cell block, and the state of the D flip flop is preserved in the input/output pad cell block although power supply to the internal logic block is stopped during the power saving.

However, according to the technology disclosed in JP-A-2004-112718, since the setting values of the cache of the CPU and the registers are saved in an external storage device before entering the power saving mode, when returning from the power saving mode, it is necessary to write the setting values to the cache. Further, according to the technology disclosed in JP-A-2003-122461, since the state of the D flip flop of the internal logic block is always copied in the RS latch, a storage medium corresponding to at least twice is necessary for the copied information. Thus, a circuit size is increased.

### SUMMARY

An advantage of some aspects of the invention is to provide an electronic circuit, a printing apparatus and an electronic apparatus, in which a power saving effect can be obtained by reducing power consumption without uselessly increasing a circuit size, and entrance to a power saving state and returning from the power saving state can be facilitated.

According to a first aspect of the invention, there is provided an electronic circuit including at least one circuit group that performs a predetermined process based on information stored in a register, wherein power supply lines are separately provided to a register, which stores data necessary for returning from a power saving state, and a circuit section other than the register, and power is supplied only to the register in the power saving state.

The circuit group, for example, is configured that a plurality of circuits perform one function as a whole, and includes a modularized circuit or the like.

The data necessary for returning from the power saving state denotes information corresponding to a result of an operation which is performed by the circuit after the circuit starts or a result of communication with an exterior. If the data is eliminated once, the data denotes information in which restoration is difficult in a program that executes an operation using the electronic circuit, and a significant temporal loss occurs when restoring a state before entering the power saving state. In other words, the data denotes information changed from the starting state of the electronic circuit.

The power supply lines are separately provided, so that the turning on/off of a power source can be separately switched with respect to the register and the circuit section other than the register. In this regard, a power supply source itself may be separately provided, or the turning on/off of the power source may be separately switched while using one power supply source.

According to the above configuration, when the electronic circuit is in the power saving state, power for the circuit section other than the register can be cut while maintaining the information of the register. Further, if returning from the power saving state, an operation process or the like before entering the power saving state can be smoothly restarted and continued by using the information of the register. Thus, power saving can be achieved, and it is possible to provide the electronic circuit in which the returning from the power saving state can be smoothly performed.

According to one preferred embodiment when the register is provided in plural number, a register area, which includes the register that stores the data necessary for returning from the power saving state, may be separated from a logic area including the circuit section other than the register. The registers are concentrically disposed in a predetermined place in the electronic circuit, so that power supply lines to a register block can be collected, thereby facilitating separation of a power source.

The preferable example of the register or the like disposed in the above-described register area may include the following, that is, a register that stores delay timing information in communication with peripheral devices of the electronic circuit, a cache memory of a CPU (Central Processing Unit), a register that stores information representing a decode range of a memory such as a ROM (Read Only Memory) and a RAM (Random Access Memory), a register that stores information representing a refresh interval of a RAM, a register that stores information representing signal timing of a ROM, or the like. The cache memory of the CPU is not necessarily needed to be configured by a register. However, if the cache memory is disposed in the register area, the cache memory serves as one element for allowing the returning from the power saving state to be smoothly performed.

According to the layout of the above-described register area in the electronic circuit, the register area may be disposed substantially in the center of the electronic circuit, disposed in a frame shape along the peripheral portion of the electronic circuit, disposed in a substantially U shape along the peripheral portion of three sides of the electronic circuit when the electronic circuit has a substantially rectangular shape, or disposed at a corner of one side of the electronic circuit.

If the register area is disposed substantially in the center of the electronic circuit, the distance between the register area and a circuit group disposed in the vicinity of the register area is totally shortened, so that interconnection length between the register in the register area and the circuit group accessing the register is totally shortened. Thus, a circuit configuration, in which interconnection delay rarely occurs, can be achieved. Further, the register area is densely disposed substantially in the center of the electronic circuit, so that the number of power supply lines to the register area can be reduced, providing advantages in terms of a circuit design and a circuit area.

If the register area is disposed in the frame shape along the peripheral portion of the electronic circuit or disposed in the substantially U shape along the peripheral portion of three sides of the electronic circuit when the electronic circuit has the substantially rectangular shape, the distance between the register area and the circuit group disposed in the vicinity of the register area is totally shortened, so that interconnection length between the register in the register area and the circuit group accessing the register is totally shortened. Thus, the circuit configuration, in which the interconnection delay rarely occurs, can be achieved.

If the register area is disposed at the corner of one side of the electronic circuit, the number of power supply lines to the register area can be reduced, so that advantages can be achieved in terms of a circuit design and a circuit area.

Meanwhile, if power supply to the circuit section other than the register is turned off in the power saving state, a potential difference occurs between the register area and the circuit section other than the register. According to one embodiment considering the potential difference, a current backflow-preventing circuit may be inserted into a line that connects the logic area to the register area. The current backflow-preventing circuit, for example, may include a logic circuit, an AND circuit or the like. The current backflow-preventing circuit is inserted, so that an abnormal operation or the like of the electronic circuit can be prevented.

Further, according to one preferred embodiment when interconnection length between the register area and the circuit group, which refers to the register disposed in the register area, exceeds a permissible interconnection length, a FF (Flip Flop) may be inserted into a line that accesses the register area from a module disposed in the logic area while being spaced away from the register area by not less than a distance which is reachable by one clock. A delay time due to interconnection delay or circuit delay is buffered by the FF, so that access to the register can be performed in a predetermined permissible clock.

Further, according to one preferred embodiment when the electronic circuit has a program execution environment, both a register, which stores an address point that is a command performed initially after returning from the power saving state, and a register, which stores a power saving flag representing the power saving state, may be disposed in the register area, and both a power saving unit, which stores the power saving flag and the address pointer in the register when entering the power saving state, and stops power supply to the circuit section other than the register while continuing power supply to the register, and a starting unit, which refers to the power saving flag at starting of the electronic circuit, executes a command of the address pointer if the starting is from the power saving state and performs a normal starting process if the starting is not from the power saving state, may be provided therein. According to such a configuration, a command having been performed up to just before entering the power saving state can be performed after returning from the power saving state. Further, since a program executed in the electronic circuit can determine the power saving flag at the starting of the electronic circuit, perform the command of the address pointer when the power saving flag exists, and perform the same process as that according to the related art when the power saving flag does not exist, an existing program can be used by slightly changing the program. Therefore, program development costs can be reduced, and smooth returning from the power saving state can be performed in the electronic circuit having the program execution environment.

The above-described electronic circuit may be realized in various embodiments. For example, the electronic circuit may be embodied after being incorporated into other electronic apparatuses or embodied together with other methods. Of course, the electronic apparatus includes a printing apparatus (printer, multi function peripheral, FAX machine or the like), a television, a digital camera, a portable phone, a portable game machine or the like. Further, the electronic apparatus including the above-described electronic circuit may be realized in various embodiments. For example, the electronic apparatus may be embodied after being incorporated into other apparatuses or embodied together with other methods. Furthermore, when the electronic circuit of the invention has a program execution environment, the invention includes a control apparatus or a control method of an electronic circuit, which has a unit or a process corresponding to each function of the program executed in the above-described electronic circuit, the program, a computer readable recording medium on which the program is recorded, or the like. The invention of the electronic apparatus, the printing apparatus, the electronic circuit control program, the medium on which the program is recorded, the electronic circuit control method and the electronic circuit control system may obtain the above-described operation and effect. Of course, configurations according to the dependent claims can be applied to the system, the method, the program and the recording medium in the dependent range.

### BRIEF DESCRIPTION OF THE DRAWINGS

The invention will be described with reference to the accompanying drawings, wherein like numbers reference like elements.

FIG. 1 is a block diagram showing one embodiment of the invention.

FIG. 2 is a conceptual view showing a circuit layout of an electric circuit.

FIG. 3 is a conceptual view between a module and a register.

FIG. 4 is a conceptual view showing a circuit layout of an electric circuit.

FIG. 5 is a conceptual view showing a circuit layout of an electric circuit.

FIG. 6 is a conceptual view showing a circuit layout of an electric circuit.

FIG. 7 is a conceptual view showing a circuit layout of an electric circuit.

FIG. 8 is a block diagram showing the function of firmware.

FIG. 9 is a flowchart showing a power saving process.

FIG. 10 is a flowchart showing a starting process.

### DESCRIPTION OF EXEMPLARY EMBODIMENTS

Hereinafter, an embodiment of the invention will be described according to the following sequence.

### 1. Configuration of Invention

1-1. Configuration of hardware

### 1-2. Layout of Electronic Circuit

### 1-3. Configuration of Software

### 2. Power Saving Process

### 3. Starting Process

### 4. Summary

### 1. CONFIGURATION OF INVENTION

### 1-1. Configuration of Hardware

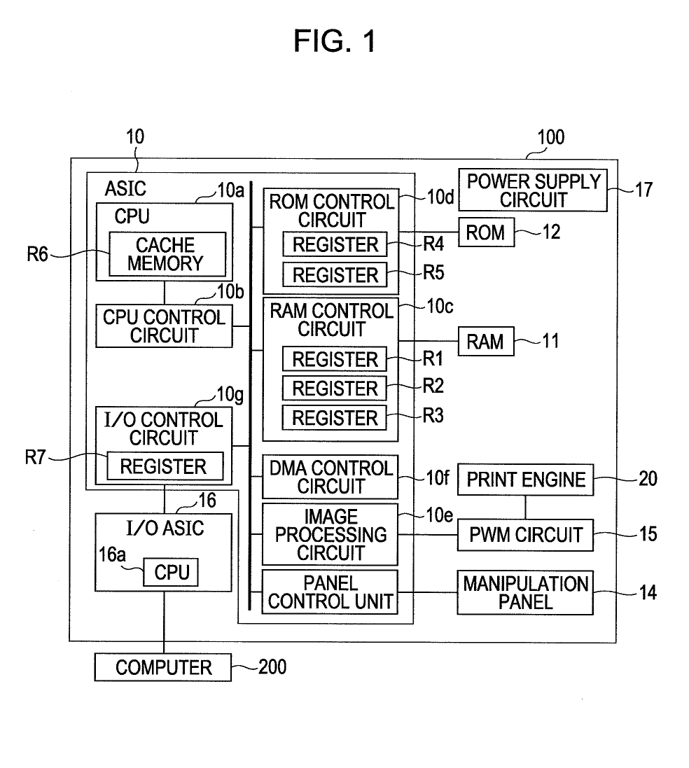

FIG. 1 is a block diagram showing one embodiment of the invention. In the embodiment as shown in FIG. 1, a printer 100 constitutes an electronic apparatus according to the invention, and an ASIC (Application Specific Integrated Circuit) 10 of the printer 100 constitutes an electronic circuit. The printer 100 includes the ASIC 10, a RAM (Random Access Memory) 11, a ROM (Read Only Memory) 12, a manipulation panel 14, a PWM (Pulse Width Modulation) circuit 15, an I/O ASIC 16, a power supply circuit 17, a print engine 20 or the like. The RAM 11, the ROM 12, the manipulation panel 14, the PWM circuit 15, the I/O ASIC 16, and the print engine 20 correspond to peripheral devices of the ASIC 10. The power supply circuit 17 supplies power to the elements 10 to 17 and 20 of the printer 100.

The manipulation panel 14 is connected to the ASIC 10 through a panel control unit. The manipulation panel 14, for example, is prepared in the form of a plurality of buttons, and is installed on the case of the printer 100. A CPU (Central Processing Unit) 10a obtains signals representing input manipulation with respect to the manipulation panel 14. Further, the manipulation panel 14 may be provided with a display panel to display various pieces of information and images based on input data.

In FIG. 1, the ASIC 10 includes the CPU 10a, a CPU control circuit 10b, a RAM control circuit 10c, a ROM control circuit 10d, an image processing circuit 10e, a DMA control circuit 10f, an I/O control circuit 10g or the like, and the control circuits 10b to 10g are connected with each other through an internal bus such that they can communicate with each other. When a program is executed, the CPU 10a fetches a command developed in the RAM 11 to a sequential command fetch unit while caching data to a cache memory R6 for which reading/writing is possible at a high speed as compared with the RAM 11. The ROM 12 stores a firmware to control the printer 100.

According to the printer 100, program data, which is stored in the ROM 12, is appropriately developed to the RAM 11 under the control of the CPU 10a in the ASIC 10, and an operation process is performed by the CPU 10a based on the program data, so that the printer 100 functions as a printer. According to the ASIC 10 of the embodiment, each of the circuits 10a to 10g is provided as a module while being fabricated in the form of a cell base IC, an embedded array ASIC, a structured ASIC or the like. One of the RAM control circuit 10c and the ROM control circuit 10d or both of them constitute a memory interface module and one of the RAM 11 and the ROM 12 or both of them constitute a memory.

The CPU control circuit 10b is connected to the CPU 10a and serves as an interface for performing signal conversion between the CPU 10a and the ASIC 10.

The RAM control circuit 10c is connected to the RAM 11 and includes a register R1, a register R2 and a register R3. Herein, address spaces, which are assigned to each memory chip constituting the RAM 11, and decode range information, which is used for regulating the capacities of each chip, are recorded in the register R1. The number and the size of the memory chips constituting the RAM 11 may vary depending on the model. The Wait number of a single read and a burst read of the RAM 11 is recorded in the register R2 by the number of clocks. A refresh interval of the RAM 11 is recorded in the register R3. The RAM control circuit 10c controls data reading/writing with respect to the RAM 11 based on the information recorded in the registers R1 to R3.

The ROM control circuit 10d is connected to the ROM 12 and includes a register R4 and a register R5. Herein, address spaces, which are assigned to each memory chip constituting the ROM 12, and decode range information, which is used for regulating the capacities of each chip, are recorded in the register R4. The number and the size of the memory chips constituting the ROM 12 may vary depending on the model. The Wait number of a single read and a burst read of the ROM 12 is recorded in the register R5 by the number of clocks. The ROM control circuit 10d controls data reading of the ROM 12 based on the information recorded in the registers R4 and R5.

The I/O control circuit 10g is connected to the I/O ASIC 16 and includes a register R7. In the register R7, delay timing information of the I/O ASIC 16 is recorded therein. The I/O ASIC 16 serves a communication interface for receiving print data from an external apparatus such as a computer 200. For example, the I/O ASIC 16 includes an interface conforming to the USB (Universal Serial Bus) standard, an interface for connection to a LAN (Local Area Network) or the like. The I/O ASIC 16 includes a CPU 16a. If the print data is received, the I/O ASIC 16 output the print data to the I/O control circuit 10g. Then, the I/O control circuit 10g obtains the print data received in the I/O ASIC 16 based on the information recorded in the register R7, and supplies the print data to the DMA control circuit 10f The DMA control circuit 10f receives the print data, which have been transmitted from the computer 200, through the I/O ASIC 16 and the I/O control circuit 10g, and stores the print data in the RAM 11. Then, the DMA control circuit 10f supplies the image processing circuit 10e with the print data of the RAM 11 by each one page under the control of the CPU 10a.

The image processing circuit 10e generates print data which is printable by the print engine 20. The image processing circuit 10e, for example, generates bit map image data, in which each pixel is represented by gradation values of each RGB color, based on the print data generated by the computer 200 while allowing a language interpretation unit to interpret the print data as required. Further, the image processing circuit 10e performs a resolution conversion process as required, and performs a color conversion process (e.g., color conversion from a RGB color space to a CMYK color space), a halftone process and a rasterize process to generate image data of each CMYK plane as the print data, and transmits the generated print data in parallel to the PWM circuit 15 in 8-bit units.

The PWM circuit 15 is connected to the print engine 20, converts the print data received from the ASIC 10 into PWM data interpretable by the print engine 20, and outputs the PWM data to the print engine 20. For example, when 8-bit parallel data (print data) is received, the PWM circuit 15 converts the received data into one-bit serial data, and sequentially transmits the converted data to the print engine 20. Then, the print engine 20 controls a toner cartridge, a photoreceptor drum, a laser beam irradiation unit, a paper feeding unit, a paper feeding and discharge unit or the like according to the print data, thereby performing a laser type printing process.

### 1-2. Layout of Electronic Circuit

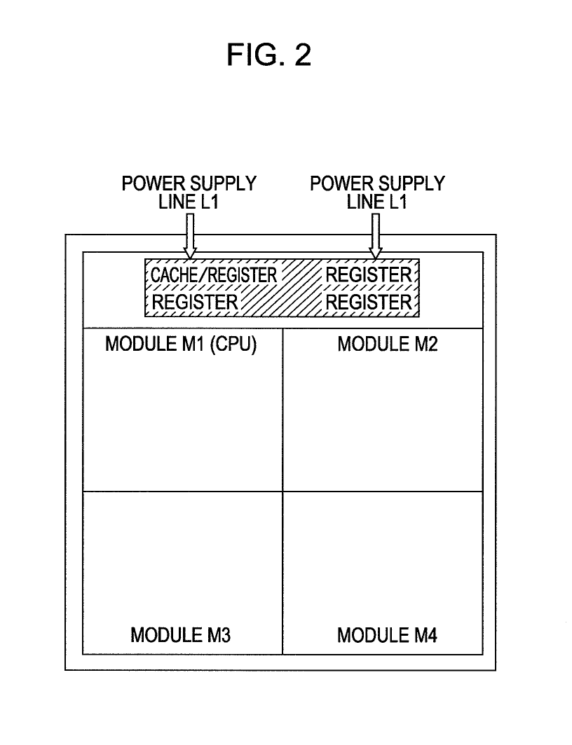

FIG. 2 is a conceptual view showing a circuit layout of the ASIC 10 as the electric circuit. The invention is not limited to the ASIC 10 exemplified in the embodiment, and can be applied to an integrated circuit such as a CPU and a chipset, an electric circuit in which a plurality of modularized circuits are densely disposed, or the like. The invention can be applied to various electric circuits if they are integrated circuits in a broad sense. Accordingly, description about the layout of the electric circuit in this clause will be given on the assumption that modules corresponding to the circuits 10a to 10g are set as four schematic modules M1 to M4, the configuration corresponding to the ASIC 10 is written as the integrated circuit 10, and the configuration corresponding to the printer 100 is written as the electronic apparatus 100.

The integrated circuit 10 having a substantially rectangular shape as shown in FIG. 2 is divided into a register area A and a logic area B by blocks. In the register area A, storage media such as registers and cache memories are disposed. The registers and cache memories store information changed after the electronic apparatus 100 starts. That is, in the register area A, an operation result, a measurement result, reception data from an exterior, which are obtained by executing firmware, or the like are recorded instead of information recorded in advance in a program (e.g., firmware) for controlling the electronic apparatus 100. If such information is lost, since a state before entering a power saving state cannot be restored, information (hereinafter, referred to as “power saving returning information”), which is necessary for restoring the state up to just before entering the power saving state, is maintained in the register area A. Meanwhile, in the logic area B, logic circuits other than the registers and cache memories, and registers, which store information unchanged after the electronic apparatus 100 starts, are disposed.

In such a state, a power supply line L1 to the register area A and a power supply line L2 to the logic area B are separated from each other. Thus, the power supply circuit 17 performs turning on/off of a power source of the logic area B separately from turning on/off of a power source of the register area A under the control of the CPU 10a or the CPU 16a. That is, the power supply circuit 17 turns off the power source of the logic area B so that power is not consumed in the logic area B, and turns on the power source of the register area A, thereby realizing a state in which the “power saving returning information” is maintained. If the logic area B is started from this state, the process before the power source of the logic area B is turned off can be easily restarted.

Herein, if an electric current is made to flow through the register area A while stopping power supply to the logic area B, a potential difference occurs between the register area A and the logic area B. Thus, backflow of electric current may occur between the registers disposed in the register area A and modules that access the registers. Accordingly, when the logic circuit of each module and the register are divided into the register area A and the logic area B, a current backflow-preventing circuit is inserted between the logic circuit and the register. A logic circuit having a current backflow-preventing function, for example, includes an AND circuit or the like. As described above, current backflow-preventing circuit is inserted between the register area A and the logic area B, so that an abnormal operation of the integrated circuit 10 can be prevented.

Various types of variations may occur in the above-described layout of the register area A and the logic area B. Hereinafter, each layout will be described with reference to FIGS. 2 to 6, and merit and demerit of each layout in each variation will be described from the standpoint of the interconnection length and number of power supply lines, and the length of an interconnection that connects the register with the logic circuit.

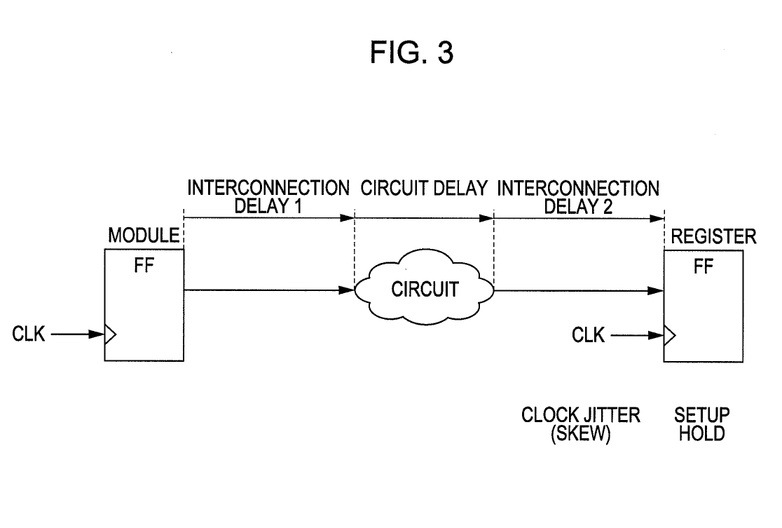

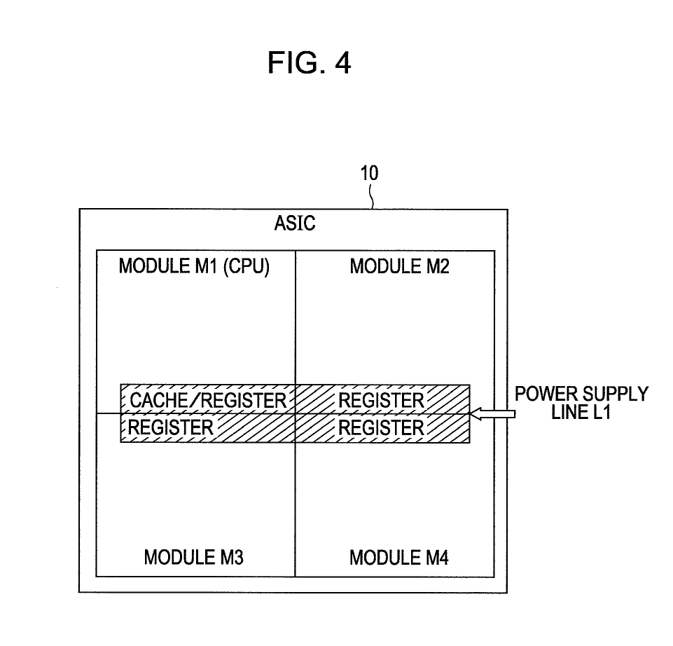

First, in the layout as shown in FIG. 2, the register area A is formed close to the corner of one side of the integrated circuit 10, and the logic area B is formed at the other part. In the layout as shown in FIG. 2, since the register area A is located at the end of the integrated circuit 10, the power supply line L1 is short. Further, since the register area A is concentrically disposed, the number of the power supply lines L1 is also reduced. A range in which power can be effectively supplied by one power supply line is limited to a predetermined range. When the logic area B includes a plurality of modules, the distance between the module and the register area A is increased. When reading and writing of a register value cannot be performed by a predetermined clock due to the increase of the distance between the module and the register area A, the measure as shown in FIG. 3 is available. The measure as shown in FIG. 3 can be applied to the layouts of FIGS. 4 to 6.

FIG. 3 is a conceptual view between a module and a register. According to the related art, one reason for blocking the circuits 10a to 10g by using modules is because interconnection delay and circuit delay of a combination circuit can be prevented from occurring in the modules by densely disposing logic circuits, which perform a bundle of processes in which a series of processes are executed in response to an external request to achieve a predetermined output, in one block. However, if a specific register in a module is disposed in a separate block according to the embodiment, interconnection delay and circuit delay may occur due to an interconnection length. The interconnection delay and circuit delay are not always constant. That is, if a case exists in which they approach 0, delay of several clocks may also occur. In this regard, according to the embodiment, when a line connecting a register with a module, which are separated from each other, exceeds a predetermined distance, for example, when a signal cannot reach by one clock, a FF (flip flop) is disposed in the middle of the line, so that variation of delay time can be suppressed.

In FIG. 3, a clock signal is supplied to a FF1 of a module side and a FF2 of a register side. In the configuration of FIG. 3, if a clock period is set as T, a transmission speed is set as K, circuit delay by a combination circuit between the FFs is set as T_{c}, interconnection delay from the FF1 to the combination circuit is set as T₁, interconnection delay from the combination circuit to the FF2 is set as T₂, a setup time of the FF is set as Tₛ, a hold time of the FF is set as Tₕ, a clock jitter (skew) is set as T_{q}, a margin considering a manufacturing variation is set as Tₘ, a permission time from the FF to the FF is set as Tₚ, and a permissible interconnection length from the FF to the FF is set as Lₚ, the permissible interconnection length Lₚ is expressed by Equation (1) below.

Lₚ=Tₚ/K (1)

### (Tₚ=T₁+T₂=T−(T_{c}+Tₛ+Tₕ+Tₕ+Tₘ))

According to Equation (1) above, for example, if the clock period T is 10 ns, the time (T_{c}+Tₛ+Tₕ+T_{cj}+Tₘ) considering the delay, the clock jitter and margin is 9.95 ns, and the transmission speed K is 5 ns/m, the Tₚ=0.05 ns (10−9.95) and the Lₚ=10 mm (0.05/5). That is, in such an example, the permissible interconnection length of the FF1 and the FF2 is 10 mm. When the line connecting the register with the module exceeds 10 mm, a signal is corrected by inserting the FF in the middle of the line, so that it is possible to cope with the delay time.

Then, in the layout of FIG. 4, the register area A is densely arranged in a substantially square shape while being disposed substantially in the center of the integrated circuit, and the logic area B is formed in a square shape to surround the register area A. According to the layout as shown in FIG. 4, the register area A is concentrically disposed in one place, and the distance between each module disposed in the logic area B and the register area A totally becomes the shortest. That is, the interconnection length between the register or the cache memory and the module using information stored therein is totally shortened.

Further, in the layout of FIG. 4, the power supply line L1 with respect to the register area A traverses the logic area B. Since the register area A is densely disposed substantially in the center of the integrated circuit, the number of the power supply lines L1 is reduced. Further, for example, if a power supply terminal is installed perpendicular to the layout surface of an integrated circuit as in the case of a PGA (Pin Grid Array), the number of the power supply lines L1 is reduced without traversing the logic area B.

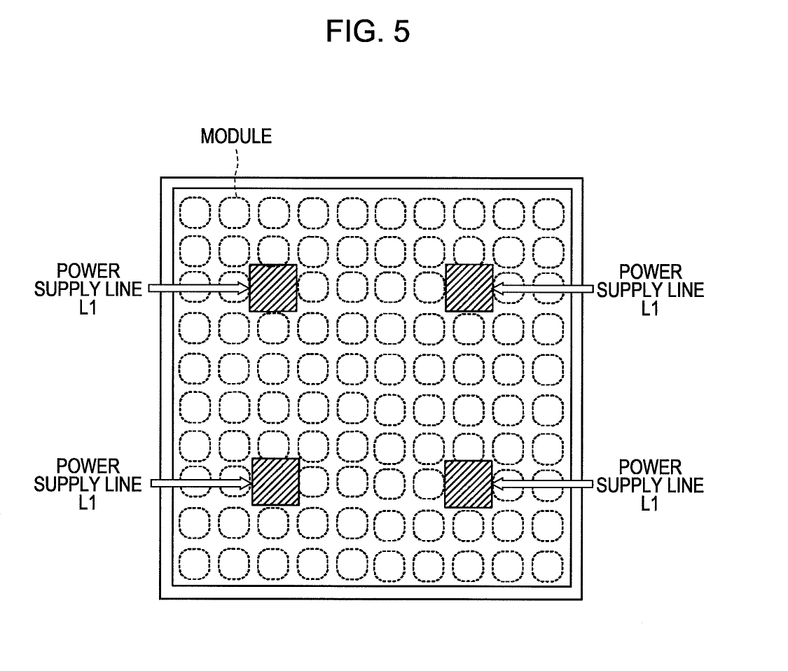

Furthermore, ideally, if each module is disposed such that a part of each module comes in contact with the register area A in relation to the logic area B, and registers of each module are disposed in positions near each module in relation to the register area A, the interconnection length can be minimized. For example, when the modules of the logic area B are provided in plural number as shown in FIG. 5, it is effective to provide a layout in which a plurality of densified register areas A are respectively formed between the modules of the logic area B, and registers or caches, which maintain the “power saving returning information” related to the modules disposed in the vicinity of the register areas A, are disposed in each register area A. This is because the interconnection length between the register area A and the logic area B becomes shortened.

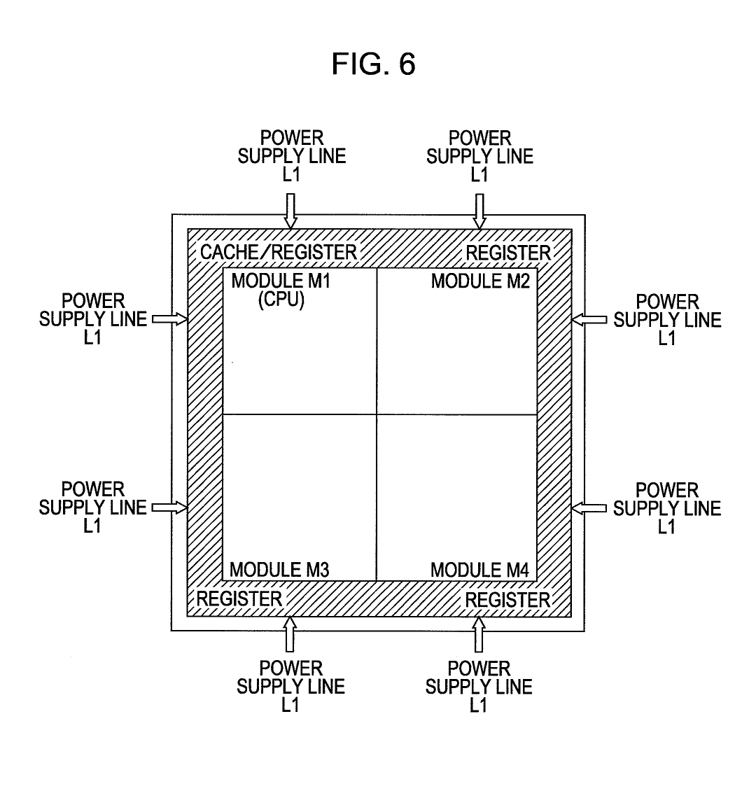

In the layout of FIG. 6, the register area A is formed in a frame shape along the peripheral portion of the integrated circuit, and the logic area B is disposed to be surrounded by the register area A. According to the layout of FIG. 6, similarly to the layout as shown in FIG. 3, the distance between each module disposed in the logic area B and the register area A is totally minimized. Thus, the length of an interconnection, which connects registers or cache memories to modules using information stored therein, can be shortened. Herein, since the register area A extends long along the peripheral portion of the integrated circuit, power supply lines with respect to the register area A must be provided in plural number. Further, in an integrated circuit such as a QFP (Quad Flat Package) provided at a side thereof with a lead, a power supply line to the register area A is the shortest.

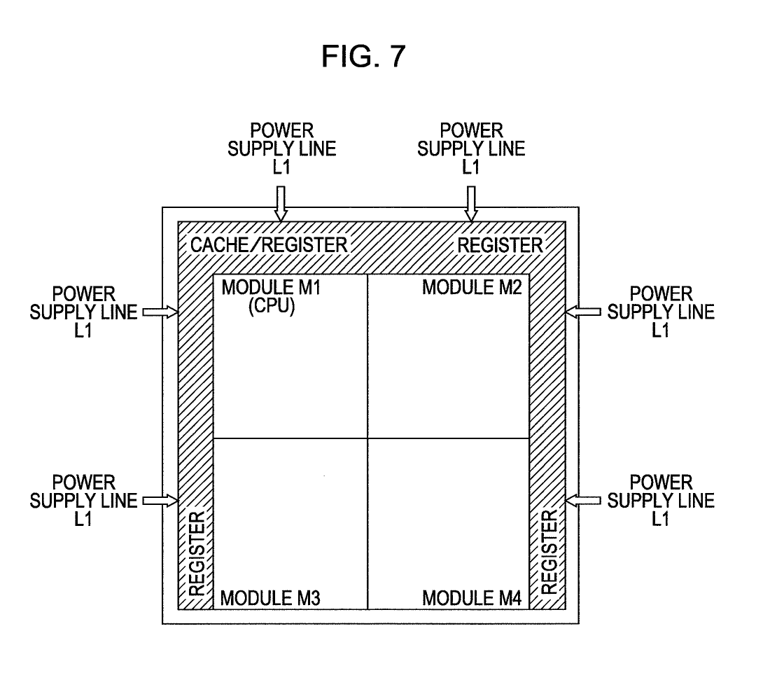

In the layout of FIG. 7, the register area A is formed in a U shape along three sides of the peripheral portion of the integrated circuit, and the logic area B is disposed to be surrounded by the register area A. Even in the layout as shown in FIG. 7, the same effect as that in the layout as shown in FIG. 6 can be obtained. Therefore, the layout of FIG. 6 or the layout of FIG. 7 is used depending on the size of the register area A and the number and the shape of the modules of the logic area B.

### 1-3. Configuration of Software

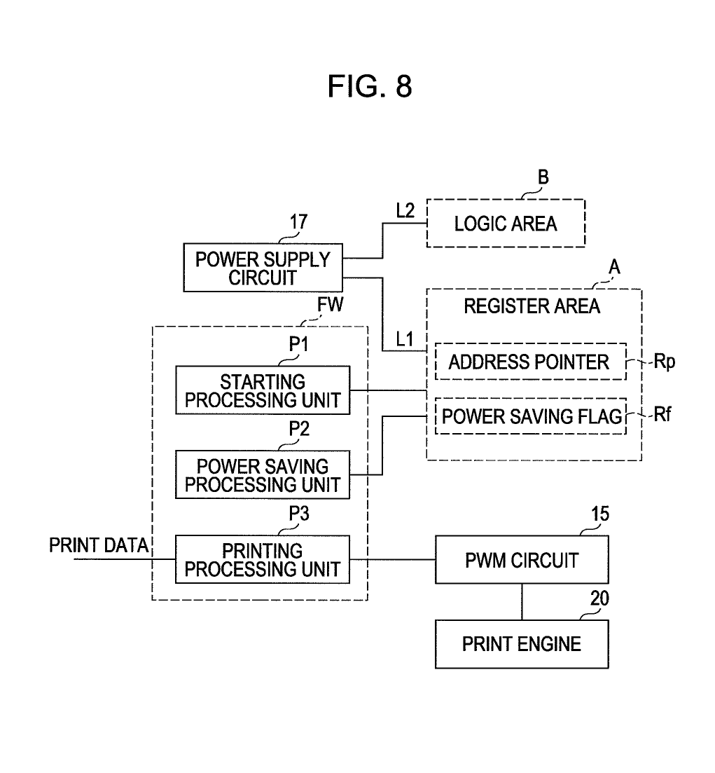

Hereinafter, the configuration of software for realizing the invention according to the above-described hardware will be described. FIG. 8 is a block diagram showing the function of firmware FW executed by the electronic apparatus. In FIG. 8, the firmware FW includes a starting processing unit P1, a power saving processing unit P2 and a printing processing unit P3. According to the embodiment, the starting processing unit P1 serves as a starting section and the power saving processing unit P2 serves as a power saving section.

If a starting signal is received through manipulation input of a user or a network, the starting processing unit P1 performs device check with respect to the elements 10 to 17 and 20 of the printer 100, and records information related to the elements 10 to 17 and 20 in a predetermined register. For example, the device check denotes a process of obtaining the capacity and decode range of the RAM 11 and the ROM12, timing information (Wait number) of a single read and a burst read of the ROM, a reading/writing test of the cache memory of the CPU 10a, access speed (Wait number) when communicating with a peripheral IC of the ASIC 10 or the like, and the information obtained through the device check is recorded in the predetermined register together with information related to each device.

The power saving processing unit P2 receives an entering command to a power saving state to allow the printer 100 to enter the power saving state. The entering command, for example, includes print data input from the computer 200 through manipulation input of the manipulation panel 14 by a user or the I/O ASIC 16. When the power saving processing unit P2 allows the printer 100 to enter the power saving state, the power saving processing unit P2 records information, which represents entrance to the power saving state, and an address pointer of a command (e.g., command fetched at the head of a command fetch unit) which must be initially performed for continuing a process in execution at the input time point of the entering command to the power saving state, in the register Rₚ of the register area A. When the starting processing unit P1 refers to the register Rₚ at the starting thereof and the information representing the entrance to the power saving state is recorded in the register R_{P}, the device check is omitted and a command indicating by the address pointer recorded in the register Rₚ is performed.

The printing processing unit P3 controls the image processing circuit 10e to generate the bit map image data, in which each pixel is represented by the gradation values of each RGB color, based on the print data, and performs the resolution conversion process as required. Further, the printing processing unit P3 performs the color conversion process (e.g., color conversion from the RGB color space to the CMYK color space), the halftone process and the rasterize process to generate the image data of each CMYK plane, and transmits the image data to the PWM circuit 15.

### 2. POWER SAVING PROCESS

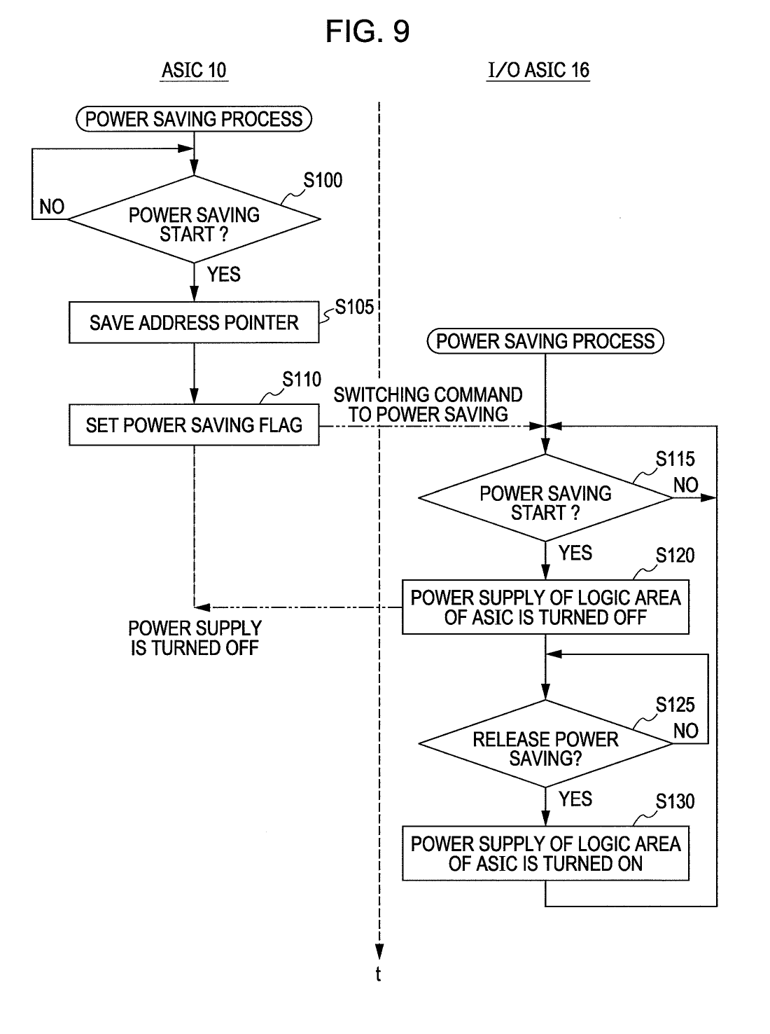

FIG. 9 is a flowchart showing the power saving process performed in the printer 100. According to the embodiment, the power saving process performed by the power saving processing unit P2 is executed by cooperation of a main program executed by the CPU 10a of the ASIC 10 and a sub-program executed by the CPU 16a of the I/O ASIC 16.

In Step S100 (hereinafter, description of “Step” will be omitted), the CPU 10a determines whether the entering command to the power saving state has been input. When the entering command has been input, the CPU 10a performs S105. However, when the entering command has not been input, the CPU 10a repeats the determination process of S100. That is, the CPU 10a always monitors input of the entering command to the power saving state during the starting of the printer 100.

In S105, the CPU 10a records an address point, which stores a command performed initially after returning from the power saving state, in the register R. The address point is maintained, so that the process before entering the power saving state can be smoothly restarted/continued upon having returned from the power saving state.

Further, when the printer according to the embodiment is a page printer, if the entering command of S100 is input during a printing process, an incomplete print result may be output and incomplete print data may remain in the RAM 11. Thus, it is preferred that the condition of S105 is allowed to be satisfied after waiting for the completion of a printing process corresponding to one page, print data of a corresponding page is configured to be maintained until the completion of the printing process corresponding to one page, and the address pointer is configured to be recorded such that the print data during printing is printed from the start at the input time point of the entering command in S105 of the description below.

In S110, the CPU 10a stores a flag (hereinafter, referred to as a power saving flag), which represents entrance to the power saving state, in the register R_{P}, and outputs the entrance command to the power saving state to the CPU 16a of the I/O ASIC 16, thereby completing the power saving process.

In the power saving state according to the embodiment, since the I/O ASIC 16 performs a process of waiting for data input from the computer 100 without entering the power saving state, the CPU 16a can perform a control process. Herein, in the invention, a sub-control subject, such as the I/O ASIC 16, other than a main control subject is not essential. When no sub-control subject exists, it is possible to use manipulation input of a power switch or the like, which is performed by a user, as a trigger which is used to switch a power state of the ASIC 10 into the power saving state or to conventionally return to the power state of the ASIC 10.

Meanwhile, the CPU 16a monitors the entering command to the power saving state, which is input from the CPU 10a. That is, while the printer 100 is operating, the CPU 16a repeats the process of determining whether the entering command to the power saving state as shown in S115 is input. If the entering command to the power saving state is input, the CPU 16a executes S120.

In S120, the CPU 16a starts the power saving process and turns off a power source of the logic area B of the ASIC 10. In more detail, the CPU 16a stops power supply to the logic area B through the power supply line L2 with respect to the power supply circuit 17. At this time, power supply to the register area A is continued. Through the above process, a control subject of the power saving process is changed into the CPU 16a.

In S125, the CPU 16a determines whether release of the power saving state has been instructed. For example, the instruction for the release of the power saving state can be performed in various manners by depressing manipulation of a power switch of the printer 100, predetermined manipulation in the manipulation panel 14, and a control command (print data or the like in the case of a printer) which is input through a network. When the release of the power saving state has been instructed, the CPU 16a executes S130. However, when the release of the power saving state has not been instructed, the CPU 16a repeats S125.

In S130, the CPU 16a turns on the power source of the logic area B of the ASIC 10. In more detail, the CPU 16a starts power supply to the logic area B through the power supply line L2 with respect to the power supply circuit 17. That is, the CPU 16a reads firmware from the ROM 12 to start execution of a starting process. In S130, a control subject of the power saving process is changed into the CPU 10a. The CPU 16a ends the power saving process, and returns to S115 to restart the process of waiting for the entering command to the power saving state, which is input from the CPU 10a.

### 3. STARTING PROCESS

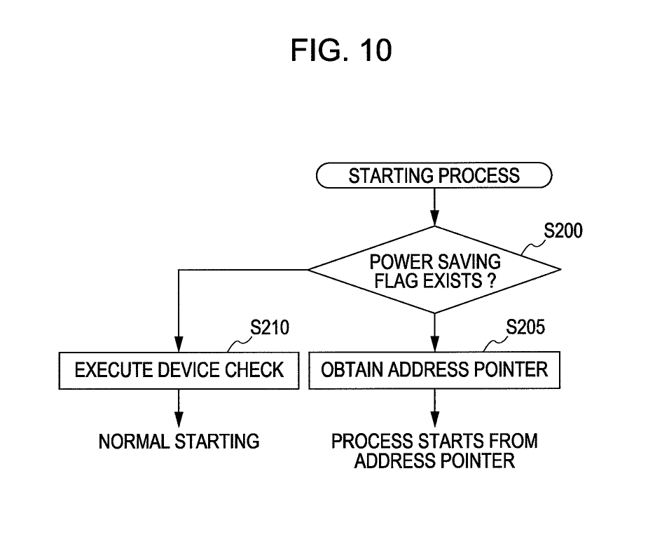

FIG. 10 is a flowchart showing the starting process performed by the starting processing unit P1. The starting process is performed not only when having returned from the power saving process, but also when the printer 100 conventionally started through manipulation of the power switch or the like. That is, the starting process is necessarily performed when the CPU 10a started the execution of firmware.

In S200, the starting processing unit P1 determined whether the power saving flag is stored in a register. When the power saving flag is stored, the starting processing unit P1 eliminates the power saving flag and executes S205. However, when the power saving flag is not stored, the starting processing unit P1 executes S210.

In S205, the starting processing unit P1 obtains the address pointer from the register to achieve a command indicated by the address pointer. Then, the starting processing unit P1 sets the achieved command in the CPU 10a such that the command is performed, thereby completing the process. The CPU 10a performs the achieved command by using the information maintained in a register or a cache according to the program of the firmware. Thus, since it is possible to restart the process before entering the power saving state without performing the device check or the like, returning from the power saving state can be smoothly performed.

In S210, the starting processing unit P1 performs the device check to store the information related to the device in a register, thereby completing the process. Then, the CPU 10a starts a process of controlling the printer 100 according to the program of the firmware.

### 4. SUMMARY

As described above, according to the printer 100 of the embodiment, in relation to the ASIC 10, the power supply lines are separately provided to the register area A, in which the registers storing the data necessary for returning from the power saving state are disposed, and the logic area B in which circuit section other than the registers are disposed, and power is supplied only to the register area A in the power saving state. Consequently, power saving can be achieved by reducing consumed power, and it is possible to provide the electronic circuit in which entrance to the power saving state and returning from the power saving state can be smoothly performed.

Further, the above-described embodiment or modified example employs the configuration of the laser printer. However, various types of printers can be employed without being limited to the laser printer. For example, it is possible to employ various printers such as ink jet printers, laser printers and SIDM (Serial Impact Dot Matrix) printers. The invention can be realized as a multi-function peripheral having a scanner function, copy function and a FAX function as well as a printer single body. Further, according to the above-described embodiment or modified example, the printer and the computer are described as an example of the electronic apparatus. However, the invention can be applied to a scanner and a FAX machine. In that sense, the invention can also be applied to various setting processes in the scanner function and the FAX function of the multi-function peripheral. In addition, the invention can also be applied to the so-called electronic apparatus, such as a television, a digital camera, a portable phone and a portable game machine, for which a user can perform various setting through a user interface.

Moreover, the invention is not limited to the above-described embodiment or modified example. For example, the invention may include a configuration obtained by replacing the configurations disclosed in the above-described embodiment and modified example with each other or changing combinations disclosed therein, a configuration obtained by replacing the configurations disclosed in the related art and the above-described embodiment and modified example with each other or changing combinations disclosed therein, or the like.

The entire disclosure of Japanese Patent Application No. 2009-031340, filed Feb. 13, 2009 is expressly incorporated by reference herein.

What is claimed is:

1. An electronic circuit comprising at least one circuit group that performs a predetermined process based on information stored in a register, wherein power supply lines are separately provided to the register, which stores data necessary for returning from a power saving state, and a circuit section other than the register, and power is supplied only to the register in the power saving state.

2. The electronic circuit according to claim 1, wherein a register area, which includes the register that stores the data necessary for returning from the power saving state, is separated from a logic area including the circuit section other than the register.

3. The electronic circuit according to claim 1, wherein a register area, which includes the register that stores the data necessary for returning from the power saving state, is separated from a logic area including the circuit section other than the register, and
the register area includes a register that stores information changed from a starting state of the electronic circuit.

4. The electronic circuit according to claim 1, wherein a register area, which includes the register that stores the data necessary for returning from the power saving state, is separated from a logic area including the circuit section other than the register, and
the register area includes a register that stores delay timing information in communication with peripheral devices of the electronic circuit.

5. The electronic circuit according to claim 1, wherein a register area, which includes the register that stores the data necessary for returning from the power saving state, is separated from a logic area including the circuit section other than the register,
the electronic circuit includes a CPU (Central Processing Unit), and
the register area includes a cache memory of the CPU.

6. The electronic circuit according to claim 1, wherein a register area, which includes the register that stores the data necessary for returning from the power saving state, is separated from a logic area including the circuit section other than the register, and
the register area includes a register that stores information representing a decode range of a memory.

7. The electronic circuit according to claim 1, wherein a register area, which includes the register that stores the data necessary for returning from the power saving state, is separated from a logic area including the circuit section other than the register, and
the register area includes a register that stores information representing a refresh interval of a RAM (Random Access Memory).

8. The electronic circuit according to claim 1, wherein a register area, which includes the register that stores the data necessary for returning from the power saving state, is separated from a logic area including the circuit section other than the register, and
the register area includes a register that stores information representing a signal timing of a ROM (Read Only Memory).

9. The electronic circuit according to claim 1, wherein a register area, which includes the register that stores the data necessary for returning from the power saving state, is separated from a logic area including the circuit section other than the register, and
the register area is disposed substantially in a center of the electronic circuit.

10. The electronic circuit according to claim 1, wherein a register area, which includes the register that stores the data necessary for returning from the power saving state, is separated from a logic area including the circuit section other than the register, and
the register area is disposed in a frame shape along a peripheral portion of the electronic circuit.

11. The electronic circuit according to claim 1, wherein a register area, which includes the register that stores the data necessary for returning from the power saving state, is separated from a logic area including the circuit section other than the register, and
the register area is disposed in a substantially U shape along a peripheral portion of three sides of the electronic circuit having a substantially rectangular shape.

12. The electronic circuit according to claim 1, wherein a register area, which includes the register that stores the data necessary for returning from the power saving state, is separated from a logic area including the circuit section other than the register, and
the register area is disposed at a corner of one side of the electronic circuit.

13. The electronic circuit according to claim 1, wherein a register area, which includes the register that stores the data necessary for returning from the power saving state, is separated from a logic area including the circuit section other than the register, and
a current backflow-preventing circuit is inserted into a line that connects the logic area to the register area.

14. The electronic circuit according to claim 1, wherein a register area, which includes the register that stores the data necessary for returning from the power saving state, is separated from a logic area including the circuit section other than the register, and
a FF (Flip Flop) is inserted into a line that accesses the register area from a module disposed in the logic area while being spaced away from the register area by not less than a distance which is reachable by one clock.

15. The electronic circuit according to claim 1, wherein a register area, which includes the register that stores the data necessary for returning from the power saving state, is separated from a logic area including the circuit section other than the register,
the register area includes a register that stores an address pointer which is a command performed initially after returning from the power saving state, and a register that stores a power saving flag representing the power saving state, and
the electronic circuit includes:
a power saving unit that stores the power saving flag and the address pointer in the register when entering the power saving state, and stops power supply to the circuit section other than the register while continuing power supply to the register; and
a starting unit that refers to the power saving flag at starting of the electronic circuit, executes a command of the address pointer if the starting is from the power saving state, and performs a normal starting process if the starting is not from the power saving state.

16. An electronic apparatus comprising electronic circuit comprising at least one circuit group that performs a predetermined process based on information stored in a register,
wherein the electronic circuit includes power supply lines, which are separately provided to a register storing data necessary for returning from a power saving state and a circuit section other than the register, and supplies power only to the register in the power saving state.

17. A printing apparatus comprising electronic circuit comprising at least one circuit group that performs a predetermined process based on information stored in a register,
wherein the electronic circuit includes power supply lines, which are separately provided to a register storing data necessary for returning from a power saving state and a circuit section other than the register, and supplies power only to the register in the power saving state.

18. The printing apparatus according to claim 17, wherein a register area, which includes the register that stores the data necessary for returning from the power saving state, is separated from a logic area including the circuit section other than the register, and
the register area includes a register that stores information on interconnection delay of a print engine.
